(19) United States
(12) Patent Application Publication
(10) Pub. No.: US 2006/0054456 A1
(43) Pub. Date: Mar. 16, 2006

(54) Mechanical coin tester

(75) Inventor: Dietmar Trennar, Berlin (DE)

Correspondence Address: YOUNG & BASILE, P.C., 3001 WEST BIG BEAVER ROAD, SUITE 624, TROY, MI, 48084, US

(73) Assignee: Walter Hanke Mechanische Werkstatten GmbH & Co. KG, Berlin (DE)

(21) Appl. No.: 11/209,486

(22) Filed: Aug. 23, 2005

(30) Foreign Application Priority Data
Aug. 23, 2004 (DE) DE-10-2004-041-67

(51) Int. Cl. G07D 5/04

(52) U.S. Cl. 194/340

(57) ABSTRACT

A mechanical coin tester with a coin insert slot and a coin runner channel connecting thereto is suggested, wherein a coin scales is allocated to the coin runner channel, said scales include an ejector projecting into the channel and a weight fastened on the ejector. The weight is adapted to the weight of a coin to be let through. A fixing element capable of being actuated by an electromagnet is allocated to the coin scales and this element fixes the ejector in its ejection position or releases it from this, depending on a control signal.

### BACKGROUND OF THE INVENTION

The invention relates to a mechanical coin tester according to the preamble of the main claim.

Mechanical coin testers are generally known and they comprise a coin insert slot which is connected to a coin runner path. Usually a window is incorporated in the wall of the coin runner channel, through which for example coins which have a smaller diameter than the height of the window may fall out of the coin runner channel and are led into the return channel. A receiver and acknowledgement region is arranged at the end of the coin runner channel, by way of which the coin is registered and led further.

A plurality of test sensors and test elements are provided in the region of the coin runner channel, which test an inserted coin with regard to thickness, weight, material properties and likewise. Such a testing means is a so-called scales which comprises an ejector articulated at a fulcrum, wherein a weight is fastened to the ejector in a manner such that the ejector in its rest condition projects into the coin running path. The ejector and weight are matched to one another in a manner dependent on the articulation scales such that a coin which falls short of a defined weight is pressed by the ejector out of the window in the wall of the coin runner channel, whilst with a greater weight of the coin, the ejector is pressed away from the coin.

Coin testers are installed into laundromats and a credit is produced by coins via the coin tester. The coin tester is blocked as soon as the credit has been reached. The coin tester is likewise blocked during a wash procedure since it may not function in an error-free manner on movement of the washing machine. The coin tester is also blocked if power cuts occur. This blocking is usually realized by way of providing slot-blocking means which close the insert slot. However, it has been shown that despite the blocking, the user attempts to push the coin past the slot barrier. Such coins however although being within the coin tester, are not counted as being correct since the credit receiver is likewise blocked. This as a rule leads to annoyance on the part of the user.

### SUMMARY OF THE INVENTION

It is the object of the invention to provide an additional coin barrier, by way of which, independently of a control signal, the coins even when they are basically valid do not get through the coin runner channel, but are ejected into the return.

According to the invention, this object is achieved by the characterizing features of the main claim in combination with the features of the preamble.

By way of the fact that the coin scales may be fixed (secured) in its ejection position by way of a fixing (securing) element which may be actuated by way of an electromagnet, one provides a further measure with a mechanical coin tester which prevents any manipulation or provides for a further possibility of return. One does not need to provide a new element but the existing scales may be provided with a second function.

Advantageous further designs and improvements are possible by way of those measures specified in the dependent claims.

### BRIEF DESCRIPTION OF THE DRAWINGS

Embodiment examples of the invention are represented in the drawing and are explained in more detail in the subsequent description. There are shown in:

FIG. 1 a part representation of a coin runner channel of a mechanical coin tester with a coin scales according to the invention, in a perspective representation with an extracted enlargement of one side of the coin channel (a), a perspective view from the other side of the coin runner channel (b), a section through the coin channel with the coin scales (c) according to the invention and a view of the coin runner channel with a coin scales according to the invention (d), wherein the ejection position is shown,

FIG. 2 a representation corresponding to FIG. 1 in the released position of the coin scales, and

FIG. 3 another embodiment of the coin scales according to the invention in a perspective representation with an enlargement, in the fixed position (a) and released position (b).

### DETAILED DESCRIPTION OF THE PREFERRED EMBODIMENT

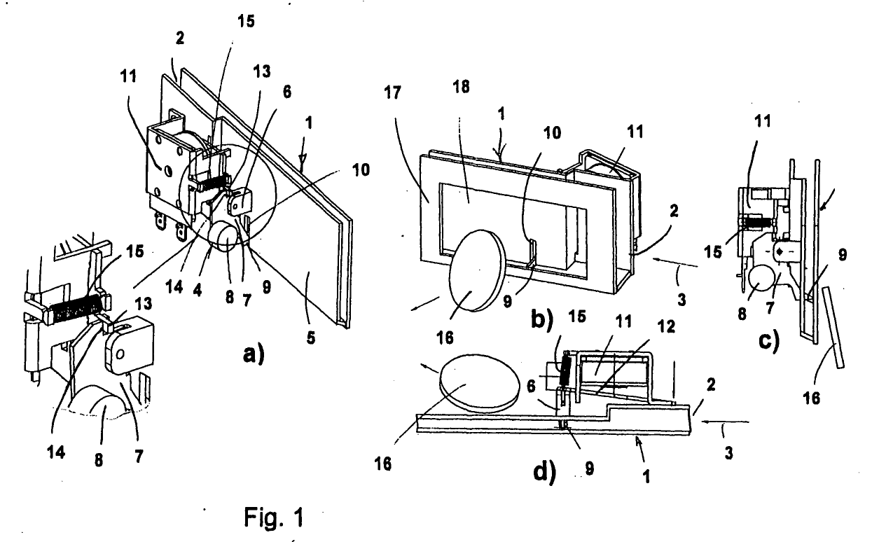

A coin channel of a mechanical coin tester is represented in FIG. 1 at 1, whose insert opening 2 connects to a coin slot which is not shown. The insert means is indicated in FIG. 1b) with the arrow 3. As may be recognized in FIG. 1a) a coin scales 4 is rotatably articulated on a side wall 5 of the coin runner channel on a suspension 6, wherein the coin scales comprises an ejector 7 and a weight 8 fastened on the ejector. The ejector with an attachment 9 projects through a slot 10 in the side wall 5 into the coin run 1, i.e., the weight, the fulcrum on the articulation 6 of the ejectors 7 and the weight of the ejector 7 are adapted to one another such that the attachment 9 in a rest position projects into the coin runner channel 1.

As may be recognized from FIG. 1, an electromagnet 11 is fastened on the side wall 5 adjacent to the coin scales 4, and this magnet comprises a metallic actuation element 12 acting as a fixing element, as may be particularly recognized from FIG. 1d). The fixing element comprises an attachment 13 which is engaged with a shoulder 14 in the ejector 7 in the rest position as is shown in FIG. 1. Furthermore, a restoring spring 15 is provided which pulls the fixing element 12 into its rest position.

The fixed position of the coin scales 4 or the locking position is shown in FIG. 1, and as may be recognized from FIG. 1b) the attachment 9 in a fixed manner projects into the coin runner channel 1. If a coin is thrown in the insert direction 3 and the magnet 11 is not activated, the coin 16 is thrown through the window 18 provided in the side wall, out of the coin runner channel and gets into the return channel. This may be seen in the various views in FIG. 1.

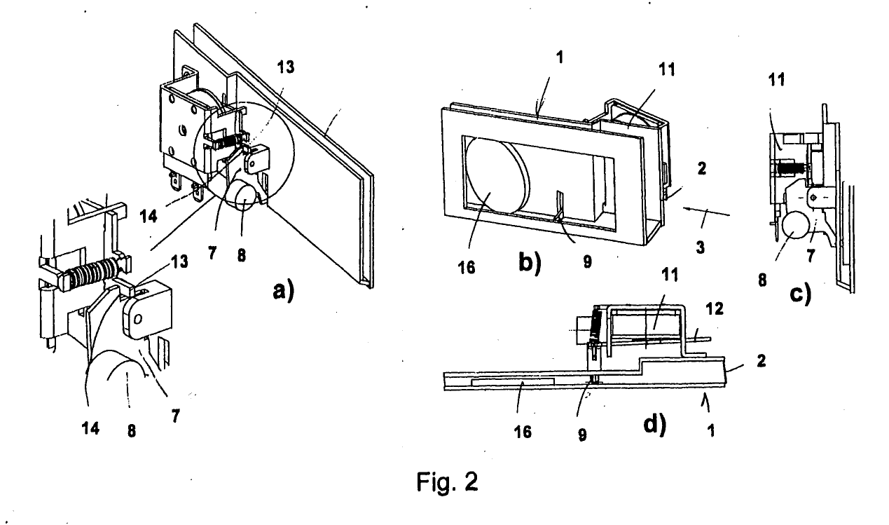

The activated position of the electromagnet 11 is to be seen in FIG. 2, wherein, as may be recognized in FIG. 2d), the fixing element 12 is attracted by the magnet 11, so that the attachment 13 moves away from the shoulder 14 of the ejector 7 against the spring force of the restoring spring 15, by which means the ejector may carry out a pivot movement. If a coin 16 is thrown into the coin runner channel 1 in the insert direction 3 and has the correct weight, it presses the ejector 9 out of the coin runner channel 1 and continues its path in the coin runner channel as is to be recognized in FIG. 2.

The electromagnet 11 is activated by a control signal which is usually supplied by the control system of the automatic machine in which the coin tester is installed.

Of course the manner of functioning may also be different, i.e., the fixing element 12 in its idle position may be arranged distanced from the shoulder 14 and with the activation of the electromagnet, may engage with the shoulder of the ejector in order to fix this and to produce an effective blocking of the coin runner channel.

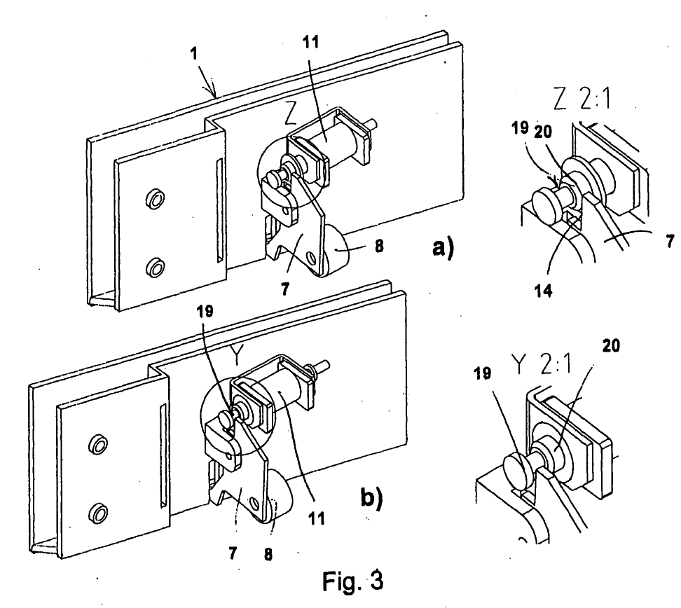

A further possibility of the fixing by the electromagnet is represented in FIG. 3, wherein the electromagnet 11 comprises an actuation element 19 which is displaced in a linear manner. This actuation element 19 serving as a fixing element comprises an arbor whose thickness is different, i.e., the fixing element consists of a region of a larger diameter 20 of the actuation element 19 which engages with the shoulder 14 of the ejector 7 in the locking position according to FIG. 3a). In the unlocked position according to FIG. 3b), the actuation element 19 is pulled back and the shoulder 14 is no longer in contact so that the ejector 7 may be pivoted. At the same time the actuation of the actuation element 19 or of the fixing element 20 in turn is dependent on a control signal which activates the magnet 11 or brings it into the rest position.

What is claimed is:

1. A mechanical coin tester with a coin insert slot and with a coin runner channel connecting thereto, wherein a coin scales is allocated to the coin runner channel, said coin scales comprising an ejector projecting into the channel and a weight fastened on the ejector, wherein the weight is adapted to the weight of a coin to be let through, characterized in that a fixing element capable of being actuated by an electromagnet is allocated to the coin scales and depending on a control signal fixes the ejector in its ejection position or releases it from this.

2. The coin tester according to claim 1, characterized in that the fixing element is engaged with the coin scales with at least one of a positive fit and non-positive fit, for blocking the ejector.

3. The coin tester according to claim 1, characterized in that the ejector is blocked in the non-activated condition of the electromagnet.

4. The coin tester according to claim 1, characterized in that the fixing element engages with a shoulder formed on the ejector, for fixing the ejector.

5. The coin tester according to claim 1, characterized in that the ejector is formed as a plate-like element which comprises an attachment projecting into the coin channel, and that the weight is fastened on the plate-like element.

6. the coin tester according to claim 2, characterized in that the ejector is blocked in the non-activated condition of the electromagnet.

7. The coin tester according to claim 2, characterized in that the fixing element engages with a shoulder formed on the ejector, for fixing the ejector.

8. The coin tester according to claim 3, characterized in that the fixing element engages with a shoulder formed on the ejector, for fixing the ejector

9. The coin tester according to claim 2, characterized in that the ejector is formed as a plate-like element which comprises an attachment projecting into the coin channel, and that the weight is fastened on the plate-like element.

10. The coin tester according to claim 3, characterized in that the ejector is formed as a plate-like element which comprises an attachment projecting into the coin channel, and that the weight is fastened on the plate-like element.

11. The coin tester according to claim 4, characterized in that the ejector is formed as a plate-like element which comprises an attachment projecting into the coin channel, and that the weight is fastened on the plate-like element.
